(19) United States
(12) Patent Application Publication
(10) Pub. No.: US 2004/0195131 A1
(43) Pub. Date: Oct. 7, 2004

(54) Snap tray for medical accessories

(75) Inventor: Michael Spolidoro, Attleboro, MA (US)

Correspondence Address: MONTE & MCGRAW, PC, 4092 SKIPPACK PIKE, P.O. BOX 650, SKIPPACK, PA, 19474, US

(73) Assignee: Medical Components, Inc., Harleysville, PA

(21) Appl. No.: 10/817,240

(22) Filed: Apr. 1, 2004

Related U.S. Application Data
(60) Provisional application No. 60/460,283, filed on Apr. 3, 2003.

(51) Int. Cl. H02N 2/00

(52) U.S. Cl. 206/438

(57) ABSTRACT

A reclosable tray for medical instruments is disclosed. The tray includes a lower portion having a first major lower side having a lower hinge portion, a second major lower side having a first lower locking portion, and a first minor lower side connecting the first major lower side and the second major lower side. An upper portion of the tray includes a first major upper side having an upper hinge portion hingedly connected to the lower hinge portion of the first major lower side, a second upper major side having a first upper locking portion, and a first minor upper side connecting the first major upper side and the second major upper side. The first lower locking portion includes a first lower tab and the first upper locking portion includes a first upper tab. The first lower tab is engageable with the first upper tab to releasably retain the second upper major side proximate to the second lower major side.

### CROSS REFERENCE TO RELATED APPLICATION

The present application claims the benefit of U.S. Provisional Patent Application Serial No. 60/460,283, filed on Apr. 3, 2003.

### FIELD OF THE INVENTION

The present invention relates to a reclosable tray for storing and transporting medical instruments and accessories.

### BACKGROUND OF THE INVENTION

Medical devices and accessories for medical procedures, such as hemodialysis catheter insertion into a patient, are typically packaged in kits, in which all of the tools and accessories necessary for the specified procedure are wholly contained. This way, all of the medical personnel involved in the procedure are assured that all of the tools required to perform the procedure are available during the procedure.

Typically, a kit includes a transparent plastic tray with compartments in which the tools and accessories. In order to maintain sterility of the articles within the kit between the time of kit assembly and use, the tray and all of the kit components are typically inserted into a TYVEK® bag that is sealed to preserve sterility.

However, during shipping, the tools and accessories in the tray compartments tend to shift and are sometimes dislodged from their intended compartments. Such shifting and dislodging makes it more difficult and time consuming for the medical personnel performing the procedure to locate and grasp the desired accessories in the tray, and also may lead to some of the accessories spilling out of the tray as the tray is being opened. It would be beneficial to provide a tray in which the tools and accessories in the kit are unable to shift and become dislodged during shipping.

### BRIEF SUMMARY OF THE INVENTION

Briefly, the present invention provides a reclosable tray for medical instruments. The tray comprises a lower portion having a first major lower side having a lower hinge portion, a second major lower side having a first lower locking portion, and a first minor lower side connecting the first major lower side and the second major lower side. An upper portion of the tray comprises a first major upper side having an upper hinge portion hingedly connected to the lower hinge portion of the first major lower side, a second upper major side having a first upper locking portion, and a first minor upper side connecting the first major upper side and the second major upper side. The first lower locking portion includes a first lower tab and the first upper locking portion includes a first upper tab. The first lower tab is engageable with the first upper tab to releasably retain the second upper major side proximate to the second lower major side.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view of a tray according to a preferred embodiment of the present invention, with the tray in an open position.

FIG. 2 is a perspective view of the tray of FIG. 1 in a closed position, with tabs interlocked to retain the tray in a closed position.

FIG. 3 is a partial side view of a locking portion of the tray along a major length of the tray, with the locking portion in a locked position.

FIG. 4 is a partial side view of a locking portion of the tray along a minor length of the tray, with the locking portion in a locked position.

### DETAILED DESCRIPTION OF THE INVENTION

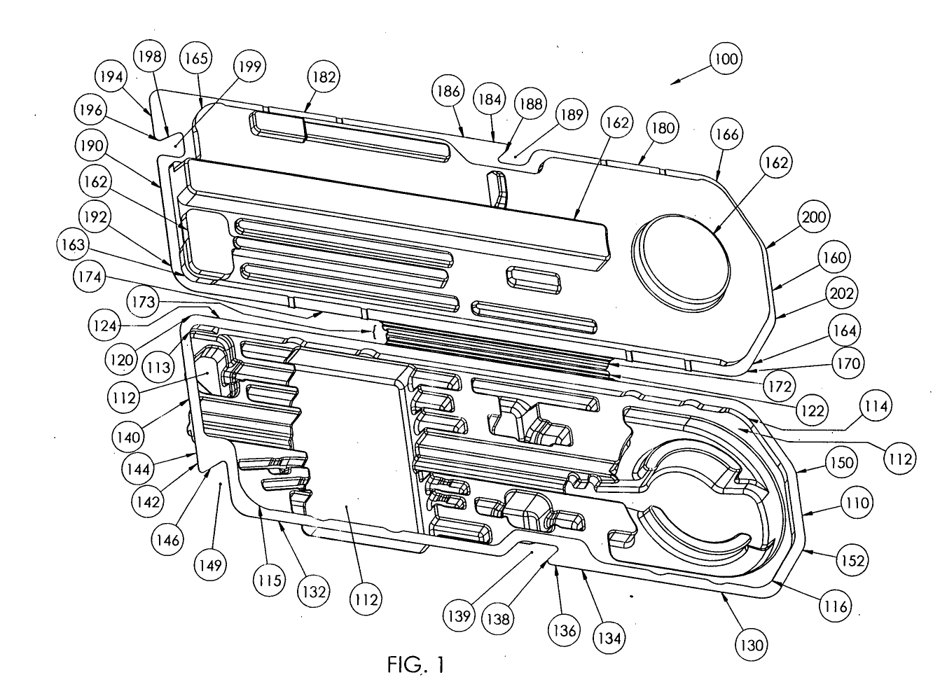

In the drawings, like numerals indicate like elements throughout. Referring to FIG. 1, a perspective view of a reclosable medical accessory tray 100 is shown. The tray 100 is shown in an open position to better illustrate the features of the tray 100. While the tray 100 shown and described is preferably used to store and transport a vascular access catheter (not shown) and accessories required for the surgical implantation of the catheter, those skilled in the art will recognize that the tray 100 of the present invention may be used to store and transport other medical devices and accessories as well.

The tray 100 includes a lower portion 110 and an upper portion 160. The lower portion 110 includes a plurality of compartments 112 for retaining medical accessories (not shown), such as, for example, a catheter and tools for inserting the catheter into a patient. Although the tray 100 is preferably used for retaining a catheter and catheter inserting tools, those skilled in the art will recognize that the tray 100 may be used for retaining other components instead.

The lower portion 110 further includes first major lower side 120. A lower hinge portion 122 extends at least partially along a length of the first major lower side 120. A lip 124 extends generally along the length of the first major lower side 120. A second major lower side 130 extends generally parallel to the first major lower side 120, on a distal side of the plurality of compartments 112 from the first major lower side 120. A lip 132 extends generally along the length of the second major lower side 130. A first minor lower side 140 connects the first major lower side 110 and the second major lower side 120. A lip 142 extends generally along the length of the first minor lower side 140. A second minor lower side 150 extends generally parallel to the first minor lower side 140, on a distal side of the plurality of compartments 112 from the first minor lower side 140. A lip 152 extends generally along the length of the second minor lower side 150. The lips 122, 132, 142, 152 are all preferably co-planar.

The second major lower side 130 includes a first lower locking portion 134. The first lower locking portion 134 is preferably a tab that includes a first exterior portion 136 that extends generally parallel to the second lower major side 130 and a first interior portion 138 that extends in a direction generally obliquely away from the first lower minor side 140. An opening 139 is disposed adjacent to the first lower locking portion 134.

The first minor lower side 140 includes a second lower locking portion 142. The second lower locking portion 142 is preferably a tab that includes a first exterior portion 144 that extends generally parallel to the first lower minor side 140 and a first interior portion 146 that extends in a direction generally obliquely away from the first lower major side 130. An opening 149 is disposed adjacent to the second lower locking portion 144.

A first lower corner 113 connects the first lower major side 120 and the first lower minor side 140. A second lower corner 114 connects the first lower major side 120 and the second lower minor side 150. A third lower corner 115 connects the second lower major side 130 and the first lower minor side 140. A fourth lower corner 116 connects the second lower major side 130 and the second lower minor side 150.

The upper portion 160 includes a plurality of indentations 162 that cooperate with the compartments 112 in the lower portion 110 when the tray 100 is in a closed position to restrain accessories (not shown) in the compartments 112 from shifting or dislodging during shipping.

The upper portion 160 further includes first major upper side 170. An upper hinge portion 172 extends at least partially along a length of the first major upper side 120. The upper hinge portion 170 is hingedly connected to the lower hinge portion 122, forming a hinge 173. A lip 174 extends generally along the length of the first major upper side 170. A second major upper side 180 extends generally parallel to the first major upper side 170. A lip 182 extends generally along the length of the second major upper side 180. A first minor upper side 190 connects the first major upper side 160 and the second major upper side 170. A lip 192 extends generally along the length of the first minor upper side 190. A second minor upper side 200 extends generally parallel to the first minor upper side 190. A lip 202 extends generally along the length of the second minor upper side 200. The lips 172, 182, 192, 202 are all preferably co-planar.

The second major upper side 180 includes a first upper locking portion 184. The first upper locking portion 184 is preferably a tab that includes a first exterior portion 186 that extends generally parallel to the second upper major side 180 and a first interior portion 188 that extends in a direction generally obliquely away from the second upper minor side 200. An opening 189 is disposed adjacent to the first upper locking portion 184.

The first minor upper side 190 includes a second upper locking portion 194. The second upper locking portion 194 is preferably a tab that includes a first exterior portion 196 that extends generally parallel to the first upper minor side 190 and a first interior portion 198 that extends in a direction generally obliquely away from the second upper major side 200. An opening 199 is disposed adjacent to the second upper locking portion 194.

A first upper corner 163 connects the first upper major side 170 and the first upper minor side 190. A second upper corner 164 connects the first upper major side 170 and the second upper minor side 200. A third upper corner 165 connects the second upper major side 180 and the first upper minor side 190. A fourth upper corner 166 connects the second upper major side 130 and the second upper minor side 150.

The tray 100 is preferably constructed from transparent polyvinyl chloride, although those skilled in the art will recognize that other materials with varying opacity may be used.

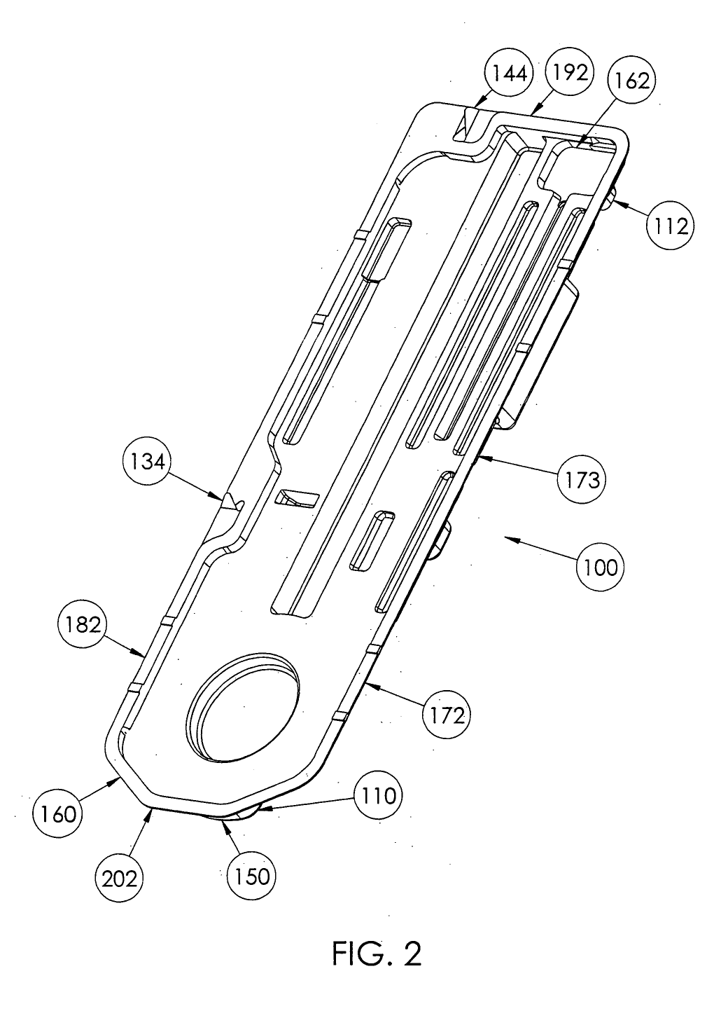

To lock the tray 100, the upper portion 160 is pivoted about the hinge 173 so that the upper portion 160 is disposed generally above the lower portion 110, as shown in FIG. 2. The upper portion 160 is closed on the lower portion 110 so that the lips 122, 132, 142, 152 are in engagement with the lips 172, 182, 192, 202, respectively. Further, the first lower corner 113 engages the first upper corner 163, the second lower corner 114 engages the second upper corner 164, the third lower corner 115 engages the third upper corner 165, and the fourth lower corner 116 engages the fourth upper corner 166, all with generally frictional fits, to further retain the upper portion 160 on the lower portion 110 when the tray 100 is in a closed position.

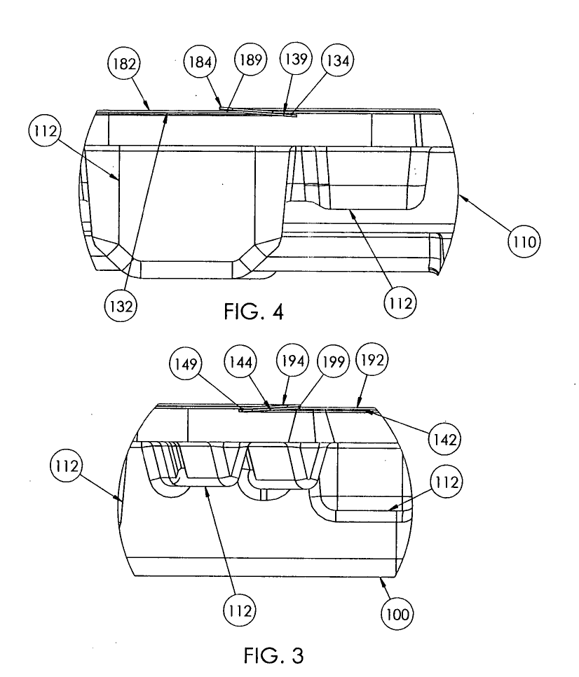

The first upper locking portion 184 is pushed downward into the opening 139, while the first lower locking portion 134 is pushed upward into the opening 189. The flexibility of the material from which the tray 100 is constructed allows the first upper locking portion 184 to be displaced below the first lower locking portion 134, as shown in FIG. 3. Similarly, the second upper locking portion 194 is pushed downward into the opening 149, while the second lower locking portion 144 is pushed upward into the opening 199. The flexibility of the material from which the tray 100 is constricted allows the second upper locking portion 194 to be displaced below the second lower locking portion 144, as shown in FIG. 4. A perspective view of the tray 100 in a closed and locked position is shown in FIG. 2.

To open the tray 100, the first upper locking portion 184 is pushed upward into the opening 189, while the first lower locking portion 134 is pushed downward into the opening 139. The flexibility of the material from which the tray 100 is constructed allows the first upper locking portion 184 to be displaced above the first lower locking portion 134. Similarly, the second upper locking portion 194 is pushed upward into the opening 199, while the second lower locking portion 144 is pushed downward into the opening 149. The flexibility of the material from which the tray 100 is constricted allows the second upper locking portion 194 to be displaced above the second lower locking portion 144. The upper portion 160 is pivoted about the hinge 173 so that the upper portion 160 is displaced away from the lower portion 110. The accessories in the compartments 112 may now be accessed.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A reclosable tray for medical instruments comprising:
a lower portion having:
a first major lower side having a lower hinge portion;
a second major lower side having a first lower locking portion; and
a first minor lower side connecting the first major lower side and the second major lower side;
an upper portion having:
a first major upper side having an upper hinge portion hingedly connected to the lower hinge portion;
a second upper major side having a first upper locking portion; and
a first minor upper side connecting the first major upper side and the second major upper side;
wherein the first lower locking portion includes a first lower tab and wherein the first upper locking portion includes a first upper tab, and wherein the first lower tab is engageable with the first upper tab to releasably retain the second upper major side proximate to the second lower major side.

2. The reclosable tray according to claim 1, wherein the lower portion comprises a plurality of compartments.

3. The reclosable tray according to claim 2, wherein the upper portion comprises a plurality of indentations adapted to cooperate with at least one of the plurality of compartments to retain at least one article in the at least on of the plurality of compartments.

4. The reclosable tray according to claim 1, wherein the tray is constructed from polyvinyl chloride.

5. The reclosable tray according to claim 1, wherein the lower portion further comprises an interior sidewall and the upper portion further comprises an exterior sidewall adapted to frictionally engage the interior sidewall at a plurality of locations along the interior sidewall.

6. The reclosable tray according to claim 1, wherein the first minor lower side comprises a second lower locking tab and the first minor upper side comprises a second upper locking tab and wherein the first lower tab is engageable with the first upper tab to releasably retain the first upper minor side proximate to the first lower minor side.

7. The reclosable tray according to claim 1, wherein the first lower locking portion includes a first tab having a first exterior portion that extends generally parallel to the second lower major side and a first interior portion that extends in a direction generally obliquely away from the first lower minor side.

8. The reclosable tray according to claim 7, wherein the first upper locking portion includes a second tab having a second exterior portion that extends generally parallel to the second upper major side and a second interior portion that extends in a direction generally obliquely toward the first upper minor side.

9. The reclosable tray according to claim 1, wherein the first upper locking portion is engageable with the first lower locking portion such that a portion of the first upper locking portion is disposable below a portion of the first lower locking portion.

10. A reclosable tray for medical instruments comprising:
a lower portion having:
a first lower side having a lower hinge portion; and
a second lower side having a first lower means for releasably locking the lower portion; and
an upper portion having:
a first upper side having an upper hinge portion hingedly connected to the lower hinge portion of the first lower side; and
a second upper side having a first upper means for releasably locking the upper portion;
wherein the first lower means and the first upper means are releasably interlockable with each other to releasably secure the second lower side to the second upper side.

11. The reclosable tray according to claim 10, wherein the lower portion further comprises a second lower means for releasably locking the lower portion and the upper portion further comprises a second upper means for releasably locking the upper portion, wherein the second lower means and the second upper means are releasably interlockable with each other to releasably secure the second lower side to the second upper side.

12. The reclosable tray according to claim 10, wherein the lower portion further comprises an interior sidewall and the upper portion further comprises an exterior sidewall adapted to frictionally engage the interior sidewall at a plurality of locations along the interior sidewall.

13. The reclosable tray according to claim 10, wherein the tray is constructed from polyvinyl chloride.

14. The reclosable tray according to claim 10, wherein the lower portion comprises a plurality of compartments.

15. The reclosable tray according to claim 14, wherein the upper portion comprises a plurality of indentations adapted to cooperate with at least one of the plurality of compartments to retain at least one article in the at least on of the plurality of compartments.
